(19) United States
(12) Patent Application Publication
(10) Pub. No.: US 2015/0110082 A1
(43) Pub. Date: Apr. 23, 2015

(54) METHOD OF HANDLING HARQ COLLISION AND PUSCH RETRANSMISSION COLLISION IN TDD

(71) Applicant: ALCATEL LUCENT, Boulogne Billancourt (FR)

(72) Inventors: Fanglei Sun, Shanghai (CN); Yan Zhao, Shanghai (CN); Huan Sun, Shanghai (CN); Jin Liu, Shanghai (CN)

(73) Assignee: Alcatel Lucent, Boulogne Billancourt (FR)

(21) Appl. No.: 14/400,187

(22) PCT Filed: Apr. 29, 2013
(86) PCT No.: PCT/IB2013/001138

§ 371 Date: Nov. 10, 2014

(30) Foreign Application Priority Data
May 11, 2012 (CN) 201210147918.X

(51) Int. Cl. H04W 72/08

(52) U.S. Cl. CPC H04W 72/082
USPC 370/336

(57) ABSTRACT

A method of handling PUSCH data retransmission collision, in a user terminal of TDD, wherein, the user terminal uses a first UL/DL configuration mode in a first radio frame, the method comprises the following steps: receiving a reconfiguration message from a base station, the reconfiguration message is used to indicate the user terminal to use a second UL/DL configuration mode in a second radio frame; judging whether PHICH for a first PUSCH data transmission is located in the first radio frame; if yes, judging whether the second radio frame includes a collision subframe, wherein, the downlink subframe occupied by the PHICH is also used to bear uplink retransmission resource allocation; when including, determining a retransmission uplink subframe used to retransmit PUSCH data by using a remapping scheme, when the second radio frame includes the collision subframe; and retransmitting the PUSCH data in the retransmission uplink subframe.

### TECHNICAL FIELD

The invention relates to a time division duplex system, particularly relates to the method of handling HARQ collision and PUSCH retransmission collision of TDD in a user terminal and a base station.

### BACKGROUND OF THE ART

In 3GPP version 11(Rel-11), the study item (SI) about “Study on Further Enhancements to LTE TDD for DL-UL Interference Management and Traffic Adaptation” is warmly discussed. In this topic, if the hybrid automatic repeat request (HARQ) feedback obeys the R10 HARQ timing, the feedback information may fall into the subframe of which eNB plans to change the UL/DL direction. E.g. for the UL-grant, the UL subframe in the radio subframe which TDD uplink and download configuration is changed may be not correctly decoded. Thus, the subframe link direction used to bear UL grant may be mismatched, wherein, the UL grant is used for the UL subframe subsequently changed. For UL retransmission with dynamic TDD UL/DL configuration, if the retransmission of a UL subframe happens on the radio frame with TDD UL/DL configuration changed, the retransmission may not be correctly implemented.

### SUMMARY OF THE INVENTION

The invention provides a method for solving the problem of UL retransmission collision in an occurrence of a TDD UL-DL reconfiguration.

According to the first aspect of the invention, a method of handling PUSCH data retransmission collision is provided, in a user terminal of a time division multiplexing system, wherein, the user terminal uses a first UL/DL configuration mode in a first radio frame, and the user terminal uses PHICH feedback to determine whether the data from PUSCH is received correctly, the method comprises the following steps: receiving a reconfiguration message from a base station, the reconfiguration message is used to indicate the user terminal to use a second UL/DL configuration mode in a second radio frame adjacent to the first radio frame; judging whether PHICH for first PUSCH data transmission is located in the first radio frame; judging whether the second radio frame includes a collision subframe if the PHICH for the first PUSCH data transmission is located in the first radio frame, wherein, the downlink subframe occupied by the PHICH for the first PUSCH data transmission is also used to bear uplink retransmission resource allocation, the collision subframe is a uplink subframe to which the uplink retransmission resource allocation is to be mapped according to the first UL/DL configuration mode, but to be configured as a subframe of downlink subframe according to the second UL/DL configuration mode; determining a retransmission uplink subframe used to retransmit PUSCH data by using a remapping scheme, when the second radio frame includes the collision subframe; and retransmitting the PUSCH data in the retransmission uplink subframe.

According to the second aspect of the invention, a method of handling PUSCH data retransmission collision is provided, in a base station of a time division multiplexing system, comprising the following steps: transmitting a reconfiguration message to a user terminal, the reconfiguration message is used to indicate the user terminal to use a second UL/DL configuration mode in a second radio frame adjacent to a first radio frame; judging whether PHICH for first PUSCH data transmission is located in the first radio frame; judging whether the second radio frame includes a collision subframe, if the PHICH for the first PUSCH data transmission is located in the first radio frame, wherein, the downlink subframe occupied by the PHICH for the first PUSCH data transmission is also used to bear uplink retransmission resource allocation, the collision subframe is a uplink subframe to which the uplink retransmission resource allocation is directed according to the first UL/DL configuration mode, but configured to be a downlink subframe according to the second UL/DL configuration mode; receiving the PUSCH data from the user terminal in the retransmission uplink subframe determined by a remapping scheme, when the second radio frame includes the collision subframe.

According to the third aspect of the invention, a method of handling PUSCH data retransmission collision is provided, in a user terminal of a time division multiplexing system, wherein, the user terminal uses the UL/DL configuration mode 0 in a first radio frame, and the user terminal uses PHICH feedback to determine whether the data from PUSCH is received correctly, the method comprises the following steps: determining whether multiple PUSCH retransmissions of the user terminal are scheduled in the same uplink subframe, when the user terminal uses a UL/DL configuration mode different with the UL/DL configuration mode 0 in a second radio frame adjacent to the first radio frame; transmitting a HARQ process identification and the PUSCH retransmission data together to a base station, when the multiple PUSCH retransmissions of the user terminal are scheduled in the same uplink subframe.

According to the fourth aspect of the invention, a method of handling PUSCH data retransmission collision is provided, in a base station of a time division multiplexing system, wherein, the base station configures the user terminal to use the UL/DL configuration mode 0 in a first radio frame, and the user terminal uses PHICH feedback to determine whether the data from PUSCH is received correctly, the method comprises the following steps: indicating that the user terminal uses a UL/DL configuration mode different with the UL/DL configuration mode 0 in a second radio frame adjacent to the first radio frame; receiving PUSCH retransmission data from the user terminal, wherein, when multiple PUSCH retransmissions of the user terminal are scheduled in the same uplink subframe, the PUSCH retransmission data further includes a HARQ process identification; decoding the retransmission data, according to the HARQ process identification.

According to the fifth aspect of the invention, a method of handling PUSCH data retransmission collision is provided, in a user terminal of a time division multiplexing system, wherein, the user terminal uses the UL/DL configuration mode 0 in a first radio frame, and the user terminal uses PHICH feedback to determine whether the data from PUSCH is received correctly, the downlink subframe occupied by the PHICH is also used to bear uplink retransmission resource allocation, and the method comprises the following steps: judging whether multiple PUSCH retransmissions are scheduled in the same uplink subframe; transmitting the PUSCH retransmission of the earliest first transmission in the scheduled uplink subframe, and implementing respective PUSCH retransmission in the uplink subframes which bears no other retransmission of the user terminal according to adjusted timing, when the multiple PUSCH retransmissions are scheduled in the same uplink subframe.

According to the sixth aspect of the invention, a method of handling PUSCH data retransmission collision is provided, in a base station of a time division multiplexing system, wherein, the base station configures the user terminal to use the UL/DL configuration mode 0 in a first radio frame, and the user terminal uses PHICH feedback to determine whether the data from PUSCH is received correctly, and the method comprises the following steps: indicating the user terminal to use a UL/DL configuration mode different with the UL/DL configuration mode 0 in a second radio frame adjacent to the first radio frame; determining whether multiple PUSCH retransmissions are scheduled in the same uplink subframe; receiving the PUSCH retransmission of the earliest first transmission in the scheduled uplink subframe, and receiving PUSCH retransmission in the uplink subframes which bear no other retransmission of the user terminal according to adjusted timing, when the multiple PUSCH retransmissions are scheduled in the same uplink subframe; decoding the retransmission of PUSCH data respectively.

According to the seventh aspect of the invention, a method of handling PUSCH data retransmission collision is provided, in a user terminal of a time division multiplexing system, wherein, the user terminal uses a first UL/DL configuration mode in a first radio frame, and the user terminal uses PHICH feedback to determine whether the data from PUSCH is received correctly, the method comprises any one of the following each items: transmitting a HARQ process identification and PUSCH retransmission data together to a base station, when multiple PUSCH retransmissions of the user terminal are mapped in the same uplink subframe; or transmitting the PUSCH retransmission of the earliest first transmission in a mapped uplink subframe, and according to the order of the first PUSCH data transmission, implementing respective other PUSCH retransmission in turn in the subsequent uplink subframes which bear no other retransmission of the user terminal.

According to the eighth aspect of the invention, an apparatus of handling PUSCH data retransmission collision is provided, in a user terminal of a time division multiplexing system, wherein, the user terminal uses a first UL/DL configuration mode in a first radio frame, and the user terminal uses PHICH feedback to determine whether the data from PUSCH is received correctly, and the apparatus comprises: a receiver, which is used to receive a reconfiguration message from a base station, the reconfiguration message is used to indicate the user terminal to use a second UL/DL configuration mode in a second radio frame adjacent to the first radio frame; a judging unit, which is used to judge whether PHICH for first PUSCH data transmission is located in a first radio frame; the judging unit is also used to judge whether the second radio frame includes a collision subframe if the PHICH for first PUSCH data transmission is located in the first radio frame, wherein, the downlink subframe occupied by the PHICH for first PUSCH data transmission is also used to bear uplink retransmission resource allocation, the collision subframe is the uplink subframe to which the uplink retransmission resource allocation is mapped according to the first UL/DL configuration mode, but configured to be a downlink subframe according to the second UL/DL configuration mode; a determining unit, which is used to determine the retransmission uplink subframe used to retransmit PUSCH data by using a remapping scheme, when the second radio frame includes the collision subframe; and a retransmitter, which is used to retransmit the PUSCH data in the retransmission uplink subframe.

It may solve the problem of HARQ retransmission collision by using the scheme in the embodiment of the invention. In addition, it may also solve the problem of retransmission collision caused by PUICH remapping, or remapping of PUSCH retransmission.

### BRIEF DESCRIPTION OF THE DRAWINGS

By reading the following detailed description of non-limiting embodiments referring to the attached drawings, other features, purposes and advantages of the invention will become clearer.

FIG. 1 (a) shows PUSCH feedback retransmission mode without using dynamic TDD UL/DL configuration mode;

FIG. 1 (b) shows the retransmission collision diagram caused by using dynamic TDD UL/DL configuration mode;

FIG. 1 (c) shows the diagram of implementing remapping in order to correctly retransmit, in case of using dynamic TDD UL/DL configuration mode;

FIG. 2 shows the diagram of implementing HARQ process under the current TDD UL/DL configuration mode;

FIG. 3 (a) shows a normal PUSCH retransmission without using dynamic TDD UL/DL configuration mode;

FIG. 3 (b) shows differentiating different PUSCH retransmission process by using HARQ process ID according to an embodiment of the invention;

FIG. 3 (c) shows handling the problem of PUSCH retransmission collision by defining new timing according to another embodiment of the invention.

### DETAILED EMBODIMENT

First, we define the terms used in the embodiment of the invention.

PUSCH, namely physical uplink shared channel, which is used to bear uplink data transport.

PHICH, namely physical HARQ indicator channel. PHICH is a downlink channel, which is used by a base station to feedback whether receiving uplink data from a user terminal. The base station transmits ACK or NACK in a PHICH.

UL grant, also called as UL resource allocation, which is the downlink resource bearing the uplink resource allocated by the base station for the user terminal.

DL subframe, namely downlink subframe.

UL subframe, namely uplink subframe. In the specification, it mainly refers to uplink retransmission resource allocation.

TTI, transmission time interval. A TTI expresses a subframe.

radio frame: a radio frame comprises 10 subframes with 0-9 number.

In the seven TDD configurations defined by the standard, in a radio frame, the number of UL subframes of configurations 1-6 is less than or equal to the number of DL subframes. While the number of UL subframes of configuration 0 is 6, which is more than the number of DL subframes which is 4. For the configurations 1-6, each UL subframe may be fed back or scheduled by a DL subframe. While for the configuration 0, since the number of DL subframes in a radio frame is less, two UL subframes may be fed back or scheduled by the same DL subframe. E.g. both of DL subframe #0 or #5 feeds back or schedule two UL subframes. Thus, in the following, for the difference of TDD UL/DL configurations before change, we divide TDD UL/DL configurations into two groups, that's: 1. UL/DL configuration modes 1-6, and 2. UL/DL configuration mode 0, and discuss their uplink retransmission respectively for the situation of the two groups. 1. the first group: UL/DL configuration modes 1-6

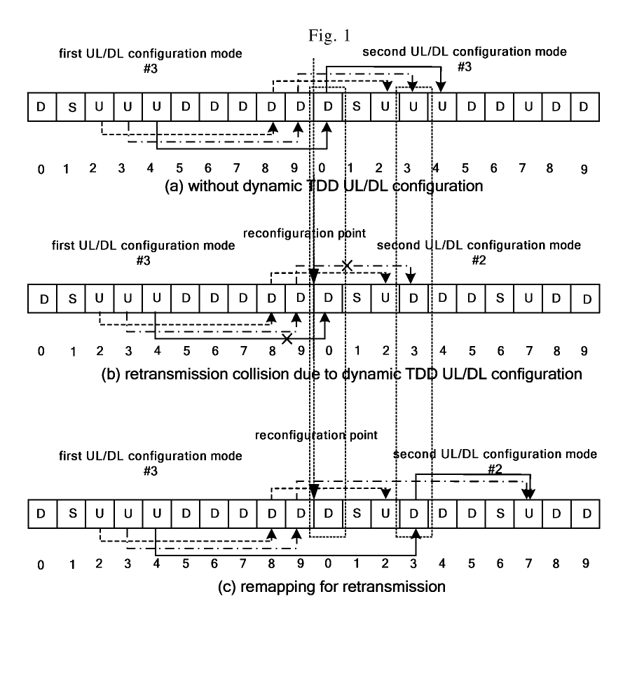

FIG. 1 (a) shows a normal ACK/NACK indication and PUSCH retransmission without using dynamic UL/DL configuration. That's, both of the first radio frame and the second radio frame use UL/DL configuration mode 3. Wherein, the subframes #8, and #9 in the first radio frame and the subframe #0 in the second radio frame are PHICH feedback for the UL subframes #2, #3 and #4 respectively, and the subframes #2, #3 and #4 in the second radio frame are PUSCH retransmission respectively scheduled by the subframes #8, #9 in the first radio frame and the subframe #0 in the second radio frame. As shown in FIG. 1(b), when TDD configuration mode changes from configuration mode 3 to configuration mode 2, namely the UL/DL configuration mode of the first radio frame is 3, the UL/DL configuration mode of the second radio frame is 2, if the PHICH of the UL subframe #2 in the first radio frame is NACK, or the base station doesn't receive the PHICH feedback from a user terminal correctly over a predetermined time even if the PHICH of the UL subframe #2 in the first radio frame is ACK, according to the HARQ timing and uplink retransmission resource allocation timing of the configuration mode 3, the retransmission of the UL subframe #2 in the first radio frame is presumed to be implemented in the subframe #2 in the second radio frame. In addition, if a transmission error occurs in the UL subframe #3, according to the HARQ timing and uplink retransmission resource allocation timing of the configuration mode 3, the retransmission of the UL subframe #3 in the first radio frame is presumed to be implemented in the subframe #3 in the second radio frame. Whereas, since the UL/DL configuration of the second radio frame changes from the UL/DL configuration mode of the first radio frame, and the UL/DL configuration mode of the second radio frame changes to the configuration mode 2, according to the second UL/DL configuration mode 2, the subframe #3 in the second radio frame is a DL subframe, and the retransmission can't be implemented correctly due to this collision. Besides, if a transmission error occurs in the UL subframe #4 in the first radio frame, according to the HARQ timing and uplink retransmission resource allocation timing of the first UL/DL configuration mode 3, the PHICH should be fed back in the DL subframe #0 in the second radio frame. Whereas, according to the second UL/DL configuration mode 2, in accordance with table 9.1.2-1 and table 8-2 of TS 36.213, E-UTRA, physical layer procedures, the subframe #0 in the second radio frame is not an effective DL subframe used to transmit traditional PHICH uplink retransmission resource allocation. As shown in the following table 1 and table 2. Table 1 shows PUSCH transmission scheduled in the subframe n by the serving cell c, and the UE determines the corresponding PHICH resource in the subframe n+k_{PHICH} of the serving cell, wherein the value of k_{PHICH} for TDD is given in table 1.

For TDD UL/DL configurations 1-6 and its normal HARQ operations, the UE should implement corresponding uplink PUSCH transmission in the n+k subframe, after detecting that the subframe n transmitted to the UE has a PDCCH with uplink DCI format (that's, including UL grant) and/or PHICH. The k value is given in table 8-2 according to the PDCCH and PHICH information.
For TDD UL/DL configuration 0 and its normal HAQR operation, the UE should implement corresponding uplink PUSCH transmission in the n+k subframe, after detecting that the subframe n transmitted to the UE has a PDCCH with uplink DCI format (that's, including UL grant) and/or PHICH. The former is that the MSB of UL identification in the PDCCH with uplink DCI format is 1, or the PHICH is received in the subframe n=0 or n=5, the resource corresponds to I_{PHICH}=0, shown as TS36.213, wherein the k value is given in table 2. If TDD UL/DL configuration is 0 and its normal HARQ operation, if the LSB of UL identification of DCI format 0/4 in the subframe n is configured as 1, or the PHICH is received in the subframe n=0 or n=5, the resource corresponds to I_{PHICH}=1, defined as 9.1.2 part of TS36.213, or the PHICH is received in the subframe n=1 or n=6, the UE should adjust corresponding PUSCH transmission in the subframe n+7. If TDD UL/DL configuration is 0, the MSB and LSB of UL identification in the PDCCH with uplink DCI format is configured in the subframe n, the UE should adjust corresponding PUSCH transmission in the subframe n+k and subframe n+7, and the k value is given in table 8-2.

TABLE 1
Table 9.1.2-1 in TS 36.213: k_{PHICH} of TDD

| TDD UL/DL | | | | | | | | | | |
|---|---|---|---|---|---|---|---|---|---|---|
| configuration | Subframe serial number n | | | | | | | | | |
| mode | 0 | 1 | 2 | 3 | 4 | 5 | 6 | 7 | 8 | 9 |

| | | | | | | |
|---|---|---|---|---|---|---|
| 0 | 4 | 7 | 6 | 4 | 7 | 6 |
| 1 | 4 | 6 | | 4 | 6 | |
| 2 | 6 | | | 6 | | |
| 3 | 6 | 6 | 6 | | | |
| 4 | 6 | 6 | | | | |
| 5 | 6 | | | | | |
| 6 | 4 | 6 | 6 | 4 | 7 | |

TABLE 2
Table 8-2 in 36.213: k of TDD UL/DL configuration mode 0-6

| TDD UL/DL | | | | | | | | | | |
|---|---|---|---|---|---|---|---|---|---|---|
| configuration | Subframe serial number n | | | | | | | | | |
| mode | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

In order to solve the above collision problem, two-step proposed in the embodiments of the invention may be used. The first step is to solve HARQ collision problem which may occur. The second step is to solve the problem of uplink retransmission resource allocation. By combing the two steps, the retransmission may be implemented correctly.

### 1.1 The First Step: HARQ Collision

In this step, according to the HARQ timing of UL/DL configuration of the first radio frame, as to the feedback for the PUSCH in the first radio frame before changing, namely the PHICH, its location may have the following three situations:

Situation 1: the PHICH is located in the first radio frame before changing.

Situation 2: the PHICH is located in the downlink subframe of the second radio frame after changing, and according to changed TDD UL/DL configuration, this downlink subframe can bear traditional PHICH or UL grant.

Situation 3: the PHICH is located in a uplink subframe of the second radio frame after changing, or although it is located in a downlink subframe of the second radio frame after changing, this downlink subframe can't be used to transmit traditional PHICH or UL grant according to table 9.1.2-1 and table 8-2 defined in 36.213. That's, in the situation 3, the PHICH collision occurs.

For situation 1 and situation 2, it may retransmit correctly according to the HARQ timing. But, for situation 3, it is needed to implement remapping. The applicant has proposed many solutions on how to solve HARQ collision, in the patent application with a number of 201210020473.9 and a title of “a method and device used for configuring subframes mapping relation in the TDD mode of LTE system”, thereby remapping the PHICH to suitable DL subframes, allowed to bear traditional PHICH, in the changed TDD UL/DL configuration mode. E.g. the PHICH of the subframe #4 of the first radio frame is remapped to a later nearest DL subframe capable of transmitting the traditional PHICH according to HARQ timing of UL/DL configuration mode 2, that's, the subframe #3 of the second radio frame, shown as FIG. 1 (c). Certainly, other solutions may be used to solve HARQ collisions.

### 1.2 The Second Step: UL Retransmission Resource Allocation Collision

Through the solution in the first step, the PHICH used for triggering retransmission of the initial PUSCH transmission can be carried in the correct DL subframe and does not result in collisions. It may find by comparing the above table 1 (Table 9.1.2-1 in TS 36.213: k_{PHICH} of TDD) and table 2(Table 8-2 in 36.213: k of TDD UL/DL configuration mode 0-6) that the suitable DL subframe which can bear PHICH and does not result in collision also can bear the DL subframe allocated by the UL resource allocation of retransmission. The above table 1 and table 2 are both applicable for Rel8/9/10. Thus, the following proposes suitable location of retransmission according to the timing of UL retransmission resource allocation of suitable DL subframe.

1.2.1

If the subframe bearing PHICH/UL retransmission resource allocation is located in the subframe before changing, the timing of UL retransmission resource allocation still obeys TDD UL/DL configuration before changing, e.g. the PHICH of the UL subframe #2 and #3 of the first radio frame are still in the subframe #8 and #9 of the first radio frame. If retransmission is needed, the retransmission will obey the UL grant timing of the first UL/DL configuration mode 3 before changing. The specification focuses on the situation that the retransmission occurs in the changing radio frame of UL/DL configuration. By obeying the timing of UL retransmission resource allocation of the subframe before changing, the UL subframe scheduled for retransmission is located in the changed second radio frame, and the following situations may be considered in detail:

Situation A: if the presumed retransmission UL subframe according to the first UL/DL configuration mode is still a uplink subframe in the changed second radio frame, such as the subframe #2 in the second radio frame, it may implement retransmission correctly, without needing remapping operation, referring to the subframe #2 in the second radio frame in FIG. 1 (c).

Situation B: if the presumed retransmission UL subframe according to the first UL/DL configuration mode is a downlink subframe in the changed radio frame, such as the subframe #3 in the second radio frame, retransmission collision occurs, needing to implement remapping to find a suitable UL subframe for retransmission.

For this situation, the following remapping scheme for retransmission is proposed.

### Scheme 1:

delaying the PUSCH retransmission to the next nearest UL subframe after the retransmission collision subframe.

### Scheme 2:

rescheduling the PUSCH retransmission to the next nearest UL subframe after the retransmission collision subframe and with a distance of at least four transmission time interval (TTI) from the DL subframe bearing the UL grant.

We may see from FIG. 1 (c), through scheme 1 or scheme 2, the retransmission of the UL subframe #3 in the first radio frame is remapped to the UL subframe #7 in the second radio frame.

### Scheme 3:

delaying the PUSCH retransmission to the next nearest UL subframe, and not scheduling any other UL retransmission of the user terminal after the collision subframe.

### Scheme 4:

scheduling the PUSCH retransmission to the next nearest UL subframe, the subframe is not scheduled with any other UL retransmission of the UE, and is at least four TTI later than the DL subframe used for bearing UL grant.

Scheme 3 and scheme 4 are supplemental to scheme 1 and scheme 2. Scheme 3 and scheme 4 have more strict limitations, that's, there is not any UL retransmission of the UE in this UL subframe.

In actual network operation, a base station and user terminals all knows what the TDD UL/DL configuration mode before and after changing respectively are, e.g. by transmitting TDD dynamic configuration instruction to a user terminal from a base station, and the base station and user terminals all knows which of the above schemes they should use to implement actual HARQ feedback and PUSCH retransmission. Thus, according to any one of the adjusted schemes 1 to 4, correspondingly, the base station transmits PHICH feedback indication, and when the downlink channel used for transmitting PHICH feedback is also used for bearing UL grant, the user terminal implements remapping according to the corresponding scheme, and implements PUSCH retransmission in the remapped uplink subframe.

Besides, LTE supports that multiple HARQ processes of the same UE occurs in the same UL subframe, and we will take the UL/DL configuration mode 0 as an example in the following second group to describe further.

1.2.2

If an effective PHICH/UL retransmission resource allocation is located in a radio frame after changing, the UL retransmission resource allocation will obey TDD UL/DL configuration after changing, e.g. the changed second radio frame schedules the UL subframe #7 that was scheduled by the DL subframe #3. If retransmission is rescheduled in the UL subframe which has already been scheduled with other UL retransmission, optionally, the rescheduling may be delayed to the next UL subframe which has not been scheduled with retransmissions of the UE. Similarly, we will take the UL/DL configuration mode 0 as an example in the second group to describe.

The second group: TDD UL/DL configuration mode 0

When TDD UL/DL configuration mode of the first radio frame before changing is 0, if the first part reason causes that HARQ scheduling collision occurs, the above proposed two-step solution is still suitable for solving the collision problem. In this part, the embodiment mainly considers the additional problem of HARQ process collision caused by the UL/DL configuration mode 0 before changing.

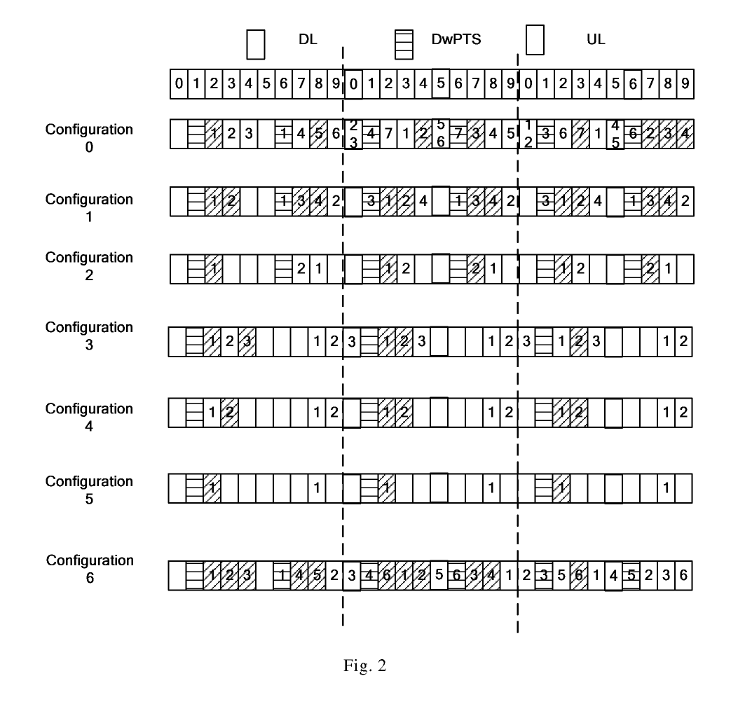

FIG. 2 shows the HARQ retransmission process. The continuous 0-9 in the top row of the figure shows the serial numbers of subframes in each radio frame. The number below in the each subframe shows the serial number of HARQ process. Wherein, the resource block occupied by shadowed diagonal lines shows the UL subframes, namely the uplink subframes.

According to FIG. 2, it may be observed that, for TDD configuration 0, in one radio frame, the number of UL subframes is 6, which is more than the number of DL subframes which are 4. Since in the radio frame the number of DL subframes is less than that of UL, the situation may exist that two UL subframes need the same downlink subframe to feed back or schedule, e.g. in the DL subframe #0 and #5. In the current TDD LTE/LTE-A system, the UL HARQ is synchronous, and may be self-adapting or not be self-adapting. This means that the base station may previously and clearly know which HARQ process the UE will transmit. Thus, the base station need not provide a user terminal with a signaling indicating the HARQ process, in the PDCCH message indicating about the uplink retransmission. FIG. 2 shows the UL HARQ process management about the seven UL/DL configurations of TDD system. It may be easily seen that, at most one UL HARQ process is supported for a specific UL subframe.

According to the PHICH timing defined in table 9.1.2-1 of TS36.213 for Rel-8/9/10, in the UL/DL configuration mode 0, the PHICH of the subframe #3 and #4 will both be transmitted in the subframe #0 of the next radio frame. If the user terminal receives a

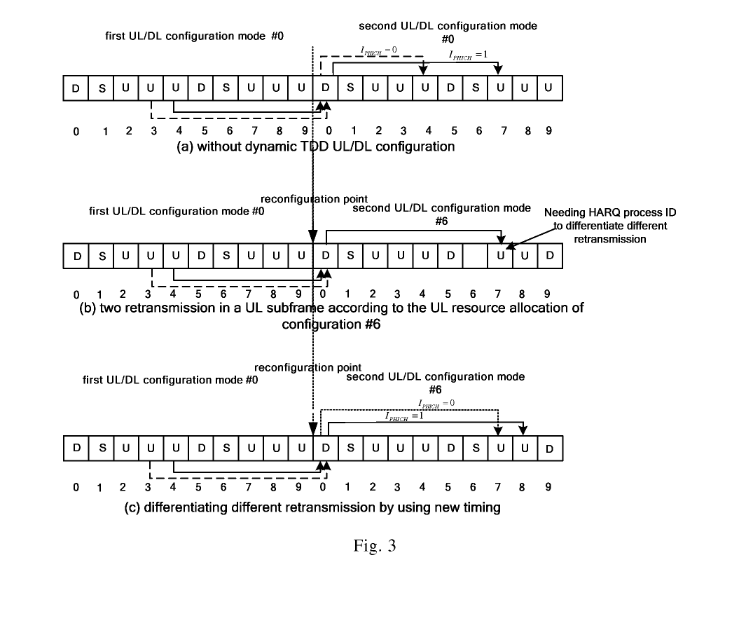

NACK of the subframe #3 and #4, and they are differentiated by I_{PHICH}=0 or I_{PHICH}=1, as defined in section 9.12 of TS36.213, the retransmission will implement the HARQ process #2 and the HARQ process #3 respectively in the subframe #4 and #7. Whereas, if TDD configuration changes from the UL/DL configuration mode 0 to e.g. the UL/DL configuration mode 6, as depicted in FIG. 3 (b), if a NACK of the subframe #3 and #4 is received in the subframe #0 of the second radio frame, according to the UL retransmission resource allocation timing of the configuration 6, the retransmission should be scheduled in the subframe #7 of the second radio frame. But, in the current TDD LTE/LTE-A system, each HARQ process relates to only one UL subframe. Scheduling multiple retransmissions in a UL subframe will cause a HARQ process collision. In order to solve this HARQ process collision, the following schemes may be proposed:

Scheme1: taking a HARQ process ID and the retransmitted PUSCH data together, and differentiating different retransmission by using the HARQ process ID, as shown in FIG. 3 (b).

Scheme2: defining different UL allocation timing for different retransmission, in detail:

For the retransmission of the earliest PUSCH first transmission, transmitting the PUSCH retransmission of earliest first transmission in the mapped uplink subframe, and according to the order of the first PUSCH data transmission, respectively implementing PUSCH retransmission in turn in the subsequent uplink subframes which bear no other retransmission of the user terminal. The purpose of this remapping scheme is ensuring that for a UE, only one HARQ retransmission occurs in one UL subframe. Since an implicit corresponding relation between the HARQ retransmission of a UE and a UL subframe is defined, the HARQ process ID is indicated implicitly by the serial number of the subframe. The base station and UEs all know the adjusted timing, and FIG. 3 (c) gives an example of this scheme.

The merit of the above scheme 1 is no need to redefine a new timing based on Rel8/9/10. However, it is needed to add additional signaling to indicate the HARQ process ID, in order to differentiate multiple retransmissions in the same UL subframe. It increases signaling overheads, and is similarly as the asynchronous HARQ not currently supported in TDD LTE UL HARQ.

Scheme 2 tries to keep a synchronous HARQ of the retransmission, thus there's no need to introduce additional signaling. But it is needed to define a new timing for different retransmissions, in order to differentiate these retransmissions to avoid retransmission collision.

In actual network operation, a base station and UEs all knows what the TDD UL/DL configuration mode before and after changing respectively are, e.g. by transmitting TDD dynamic configuration instruction to a user terminal from a base station, and the base station and user terminals all knows which of the above schemes they should use to implement actual HARQ feedback and PUSCH retransmission. Thus, according to any one of the adjusted schemes, correspondingly, the base station transmits PHICH feedback indication, and when the downlink channel used for transmitting PHICH feedback is also used for bearing retransmission UL grant, the user terminal implements remapping and PUSHCH retransmission in the remapped uplink subframe, according to the corresponding scheme.

Optionally, when it is supported to transmit multiple retransmissions of the same UE in a UL subframe, in order to differentiate which HARQ process the PUSHCH retransmission is for, when a user terminal implements retransmission, it may further attach a HARQ process identification in the retransmission data, thus avoiding the PUSCH retransmission collision.

Though herein taking the UL/DL configuration mode 0 before changing as an example to elucidate, according to the disclosure of the specification, those skilled in the art can understand that the above problem of avoiding PUSCH retransmission collision also exists in the first group, as shown in FIG. 1(c) of the uplink subframe #7 in the second radio frame.

That's, when multiple uplink retransmission resource allocations of the same user terminal are mapped to the same uplink subframe, the user terminal may transmit a HARQ process identification and the PUSCH retransmission data together to a base station; or transmitting the PUSCH retransmission of the earliest first transmission in the mapped uplink subframe, and according to the order of the first PUSCH data transmission, respectively implementing other PUSCH retransmission in turn in the subsequent uplink subframes which bear no other retransmission of the user terminal. E.g. after the user terminal adjusts the retransmission timing, the first transmission corresponding to the retransmission mapped to the subframe #7 of the second radio frame are both of the subframe #3 and the subframe #4 of the first radio frame, since the first transmission of the subframe #3 is in advance and the first transmission of the subframe #4 is later, the subframe #7 of the second radio frame is scheduled to the retransmission of the subframe #3 of the first radio frame, and the retransmission of the subframe #4 of the first radio frame is delayed to a subsequent uplink subframe that has not been allocated the user terminal for retransmission and is capable of retransmission.

The above describes the embodiment of the invention from the view of method process, and the following will describe the invention from the view of the apparatus.

The apparatuses of handling PUSCH data retransmission collision in a user terminal comprise a receiver, a judging unit, a determining unit, and a retransmitter. Wherein, the user terminal uses a first UL/DL configuration mode in a first radio frame, and the user terminal uses PHICH to feed back whether receiving the data from PUSCH correctly.

First, the receiver is used to receive a reconfiguration message from a base station, and the reconfiguration message is used to indicate the user terminal to use a second UL/DL configuration mode in a second radio frame adjacent to the first radio frame.

Next, the judging unit is used to judge whether PHICH for first PUSCH data transmission is located in a first radio frame. The judging unit is also used to judge whether the second radio frame includes a collision subframe if the PHICH for first PUSCH data transmission is located in the first radio frame, wherein, the downlink subframe occupied by the PHICH for first PUSCH data transmission is also used to bear uplink retransmission resource allocation, and the collision subframe is the uplink subframe to which the uplink retransmission resource allocation is mapped according to the first UL/DL configuration mode, but is configured to be a downlink subframe according to the second UL/DL configuration mode.

Next, the determining unit is used to determine a retransmission uplink subframe used to retransmit PUSCH data by using a remapping scheme, when the second radio frame includes the collision subframe; and

Then, the retransmitter is used to retransmit the PUSCH data in the retransmission uplink subframe.

The above describes the embodiment of the invention, but the invention isn't limited to the special system, device and detail protocol, the technical personnel of the field may do various deformation or modification within the range of the attached claims.

Those ordinary skilled in the art may understand and implement other changes for the disclosed embodiment, by studying the specification, disclosure, the drawings and the claims. In the claims, the word “comprise” doesn't exclude other components and steps, and the word “a” doesn't exclude plural. In the invention, “first”, and “second” only indicate name, not representing any order relationship. In the actual application of the invention, one component may implement the functions of multiple technical features quoted in the claims. Any reference signs in the claims should not be understood as a limitation to the scope of the claims.

1. A method of handling PUSCH data retransmission collision, in a user terminal of a time division multiplexing system, wherein, the user terminal uses a first UL/DL configuration mode in a first radio frame, and the user terminal uses PHICH feedback to determine whether the data from PUSCH is received correctly, the method comprises:
receiving a reconfiguration message from a base station, the reconfiguration message is used to indicate the user terminal to use a second UL/DL configuration mode in a second radio frame adjacent to the first radio frame;
judging whether PHICH for a first PUSCH data transmission is located in the first radio frame;
judging whether the second radio frame includes a collision subframe if the PHICH for the first PUSCH data transmission is located in the first radio frame, wherein, the downlink subframe occupied by the PHICH for the first PUSCH data transmission is also used to bear a uplink retransmission resource allocation, the collision subframe is a uplink subframe to which the uplink retransmission resource allocation is to be mapped according to the first UL/DL configuration mode, but to be configured as a downlink subframe according to the second UL/DL configuration mode;
determining a retransmission uplink subframe used to retransmit PUSCH data by using a remapping scheme, when the second radio frame includes the collision subframe; and
retransmitting the PUSCH data in the retransmission uplink subframe.

2. A method of claim 1, wherein, the remapping scheme comprises using a remapped uplink subframe, determined according to any one of the following items, as the retransmission uplink frame:
taking the nearest uplink subframe after the collision subframe as the remapped uplink frame;
taking the nearest uplink subframe with an interval of more than four TTI after the collision subframe as the remapped uplink frame;
taking the nearest uplink subframe after the collision subframe as the remapped uplink frame, and after the collision subframe, no longer scheduling any uplink retransmission of the user terminal;
taking the nearest uplink subframe with an interval of more than four TTI after the collision subframe as the remapped uplink frame, and after the collision subframe, no longer scheduling any uplink retransmission of the user terminal.

3. A method of claim 1, wherein, when multiple uplink retransmission resource allocations of the user terminal are mapped to the same uplink subframe simultaneously, the retransmitting further comprises:
transmitting a HARQ process identification and PUSCH retransmission data together to the base station.

4. A method of claim 2, wherein, when multiple uplink retransmission resource allocations of the user terminal are mapped to the same uplink subframe simultaneously, the determining further comprises:
transmitting the retransmission of the earliest first PUSCH data transmission in the mapped uplink subframe, and respectively implementing PUSCH retransmission in turn in subsequent uplink subframes which bear no other retransmission of the user terminal according to the order of the first PUSCH data transmission.

5. A method of claim 1, wherein, after the judging whether PHICH for a first PUSCH data transmission is located in the first radio frame, the method further comprises:
determining whether the uplink subframe used for retransmission, to which the uplink retransmission resource allocation is directed in the second UL/DL configuration mode, is not scheduled for retransmission, if the PHICH for first PUSCH data transmission is located in the second radio frame, and the downlink subframe occupied by the PHICH for the first PUSCH data transmission is also used to bear uplink retransmission resource allocation;
remapping the uplink subframe used for retransmission to a next uplink subframe which is not scheduled to the user terminal for retransmission, if the uplink subframe is already scheduled for retransmission.

6. A method of handling PUSCH data retransmission collision, in a base station of a time division multiplexing system, comprising:
transmitting a reconfiguration message to a user terminal, the reconfiguration message is used to indicate the user terminal to use a second UL/DL configuration mode in a second radio frame adjacent to a first radio frame;
judging whether PHICH for a first PUSCH data transmission is located in the first radio frame;
judging whether the second radio frame includes a collision subframe, if the PHICH for the first PUSCH data transmission is located in the first radio frame, wherein, the downlink subframe occupied by the PHICH for the first PUSCH data transmission is also used to bear a uplink retransmission resource allocation, the collision subframe is a uplink subframe to which the uplink retransmission resource allocation is directed according to the first UL/DL configuration mode, but configured to be a downlink subframe according to the second UL/DL configuration mode;
receiving the PUSCH data from the user terminal in a retransmission uplink subframe determined by a remapping scheme, when the second radio frame includes the collision subframe.

7. A method of handling PUSCH data retransmission collision, in a user terminal of a time division multiplexing system, wherein, the user terminal uses the UL/DL configuration mode 0 in a first radio frame, and the user terminal uses PHICH feedback to determine whether the data from PUSCH is received correctly, the method comprises:
determining whether multiple PUSCH retransmissions of the user terminal are scheduled in the same uplink subframe, when the user terminal uses a UL/DL configuration mode different with the UL/DL configuration mode 0 in a second radio frame adjacent to the first radio frame;
transmitting a HARQ process identification and the PUSCH retransmission data together to a base station, when the multiple PUSCH retransmissions of the user terminal are scheduled in the same uplink subframe.

8. A method of handling PUSCH data retransmission collision, in a base station of a time division multiplexing system, wherein, the base station configures a user terminal to use the UL/DL configuration mode 0 in a first radio frame, and the user terminal uses PHICH feedback to determine whether the data from PUSCH is received correctly, the method comprises:
indicating that the user terminal uses a UL/DL configuration mode different with the UL/DL configuration mode 0 in a second radio frame adjacent to the first radio frame;
receiving PUSCH retransmission data from the user terminal, wherein, the PUSCH retransmission data further includes a HARQ process identification when multiple PUSCH retransmissions of the user terminal are scheduled in the same uplink subframe;
decoding the retransmission data according to the HARQ process identification.

9. A method of handling PUSCH data retransmission collision, in a user terminal of a time division multiplexing system, wherein, the user terminal uses the UL/DL configuration mode 0 in a first radio frame, and the user terminal uses PHICH feedback to determine whether the data from PUSCH is received correctly, a downlink subframe occupied by the PHICH is also used to bear a uplink retransmission resource allocation, and the method comprises:
judging whether multiple PUSCH retransmissions are scheduled in the same uplink subframe;
transmitting the PUSCH retransmission of the earliest first transmission in the scheduled uplink subframe, and implementing respective PUSCH retransmission in the uplink subframes which bear no other retransmission of the user terminal according to adjusted timing, when the multiple PUSCH retransmissions are scheduled in the same uplink subframe.

10. A method of handling PUSCH data retransmission collision, in a base station of a time division multiplexing system, wherein, the base station configures a user terminal to use the UL/DL configuration mode 0 in a first radio frame, and the user terminal uses PHICH feedback to determine whether the data from PUSCH is received correctly, and the method comprises:
indicating the user terminal to use a UL/DL configuration mode different with the UL/DL configuration mode 0 in a second radio frame adjacent to the first radio frame;
determining whether multiple PUSCH retransmissions are scheduled in the same uplink subframe;
receiving the PUSCH retransmission of the earliest first transmission in the scheduled uplink subframe, and receiving PUSCH retransmission in the uplink subframes which bear no other retransmission of the user terminal according to adjusted timing, when the multiple PUSCH retransmissions are scheduled in the same uplink subframe;
decoding the retransmitted PUSCH data respectively.

11. A method of handling PUSCH data retransmission collision, in a user terminal of a time division multiplexing system, wherein, the user terminal uses a first UL/DL configuration mode in a first radio frame, and the user terminal uses PHICH feedback to determine whether the data from PUSCH is received correctly, the method comprises any one of the following each items:
transmitting a HARQ process identification and PUSCH retransmission data together to a base station, when multiple PUSCH retransmissions of the user terminal are mapped in the same uplink subframe; or
transmitting the PUSCH retransmission of the earliest first transmission in a mapped uplink subframe, and implementing respective other PUSCH retransmission in turn in the subsequent uplink subframes which bear no other retransmission of the user terminal according to the order of the first PUSCH data transmission.

12. An apparatus of handling PUSCH data retransmission collision, in a user terminal of a time division multiplexing system, wherein, the user terminal uses a first UL/DL configuration mode in a first radio frame, and the user terminal uses PHICH feedback to determine whether the data from PUSCH is received correctly, and the apparatus comprises:
a receiver, which is used to receive a reconfiguration message from a base station, the reconfiguration message is used to indicate the user terminal to use a second UL/DL configuration mode in a second radio frame adjacent to the first radio frame;
a judging unit, which is used to judge whether PHICH for first PUSCH data transmission is located in the first radio frame;
the judging unit is further used to judge whether the second radio frame includes a collision subframe if the PHICH for first PUSCH data transmission is located in the first radio frame, wherein, the downlink subframe occupied by the PHICH for first PUSCH data transmission is also used to bear a uplink retransmission resource allocation, the collision subframe is the uplink subframe to which the uplink retransmission resource allocation is mapped according to the first UL/DL configuration mode, but configured to be a downlink subframe according to the second UL/DL configuration mode;
a determining unit, which is used to determine the retransmission uplink subframe used to retransmit PUSCH data by using a remapping scheme, when the second radio frame includes the collision subframe; and
a retransmitter, which is used to retransmit the PUSCH data in the retransmission uplink subframe.
